(19) United States
(12) Patent Application Publication
(10) Pub. No.: US 2003/0079758 A1
(43) Pub. Date: May 1, 2003

(54) Process and composition for removing biofilm

(76) Inventors: Phyllis B. Siegel, San Antonio, TX (US); Norman I. Bruckner, Plano, TX (US)

Correspondence Address: JOHN LEZDEY, 1409A NORTH FT HARRISON, CLEARWATER, FL, 33755, US

(21) Appl. No.: 10/072,432

(22) Filed: Feb. 8, 2002

Related U.S. Application Data
(63) Continuation-in-part of application No. 09/089,845, filed on Jun. 3, 1998, now abandoned.
(63) Continuation-in-part of application No. 09/608,048, filed on Jun. 30, 2000.

(51) Int. Cl. B08B 9/032; A01N 1/00

(52) U.S. Cl. 134/3; 422/28; 134/22.18; 134/28; 510/161

(57) ABSTRACT

A composition and a method for decontaminating small diameter water lines for medical equipment which effectively dislodges and eliminates a biofilm and at the same time destroy the microorganism flora in the fresh water and in the dislodged biofilm. In addition the composition or method does not corrode water line materials, it is safe and non-toxic, it does not expose patients to the decontaminaiting chemicals or process, it does not leave significant residual chemicals in the water line, it does not require the use of sterile solutions and aseptic technique by dental personel, and it does not require mixing or dilution of chemicals prior to use.

### CROSS REFERENCE TO RELATED APPLICATIONS

This application is a continuation-in-part of application Ser. No. 09/089.845, filed Jun. 3, 1998, now abandoned.

### GOVERNMENT INTERESTS

DESCRIPTION

This invention was made with government support under grants awarded by the National Institutes of Health. The government has certain rights in this invention.

### BACKGROUND OF THE INVENTION

1. Field of the Invention

The present invention relates to an improved method for effectively decontaminating biofilm-coated surfaces. Types of surfaces comprise: the inner surface of aqueous liquid-supplying lines, particularly fresh water lines such as those supplying water to medical devices such as dental unit water lines (DUWL) and dialysis units. More particularly, the present invention relates to methods for dislodging biofilm formed or accumulated on contaminated surfaces for destroying the microorganisms contained therein. The preferred compositions are particularly suitable for water pipes of dental instruments and of dialysis units which are of a small diameter, because no scrubbing is needed for maximal efficiency in a convenient time of decontamination.

2. Description of the Relevant Art

The Center for Disease Control and Prevention (CDC) has issued recommendations which apply to water to be supplied to dental units during invasive procedures often encountered in dental treatments. (Center for Disease Control and Prevention: Recommended infection-control practices for dentistry, 1993. MMWR 42: No.RR-8:7, 1993.). According to B. G. Shearer in “Biofilm and the dental office,” Journal of the American Dental Association, Vol. 127, No. 2, 1996, the American Dental Association has set forth goals for the year 2000 whereby all water delivered to dental patients will have no more than 200 colony forming units (CFU) of live bacteria per cubic milliliter. These recommendations and their application to dentistry are discussed in Waggoner, M. B., “The New CDC Surgical Water Recommendations: Why They Should Be Implemented and What They Require,” Compendium, Vol. 17, No. 6, June 1996.

The microorganisms can range from relatively harmless bacteria to dangerous pathogens. Consequently, efforts are deployed to remove microorganisms from dental instruments and from the fresh water lines feeding dental instruments such as air/water guns, high speed water turbines or ultrasonic tartar removers. For most hand held dental instruments, thermal sterilization remains one of the best methods for eradicating the presence of microorganisms. However, thermal sterilization is obviously not practical for the decontaminating of fresh water lines which remain to this date difficult to rid of microorganisms.

It is well known in the medical and dental professions that small diameter pipes carrying fresh water are contaminated by bacteria and other microorganisms contained in the water flowing through them. Some of the microorganisms inevitably adhere to the inner walls of the pipes and accumulate together with microscopic sediments or other substances into what is commonly known as a biofilm. Costerton J W, et al. Science 284:1318-22 (1999) presence a concise description of biofilms and the problems that they present for the medical and dental professions. Within a biofilm, bacteria aggregate in a hydrated polymeric matrix of their own synthesis to form a sessile community that is inherently resistant to antimicrobial agents. The biofilm quickly and tenaciously coats the inner walls of the pipes. The biofilm becomes a culture medium for more microorganisms. The bacterial population will rapidly reach alarming levels of bacteria in the water discharge from the dental instruments connected to the fresh water line. The biofilm itself, and not the municipal water, is the major source of bacterial contamination The average bacteria count in the water discharge of dental instruments, for example, is known to be of approximately 200,000 colony forming units per milliliter (cfu/ml) and in some extreme cases can reach 10,000,000 cfu/ml.

Mature biofilms are much more difficult to treat than water-born free bacteria. For example, as disclosed by Vess et al in “The colonization of solid PVC surfaces and the acquisition of resistance to germicides by water micro-organisms,” Journal of Applied Bacteriology, Vol. 74, No. 2, 1993, bactericides such as free chlorine in a concentration of only a few parts per million are well-known bactericides which readily kill water-born bacteria. However, such bactericides are recognized to be ineffective in killing mature biofilms. Mature biofilms can generally be characterized as relatively thick colonies of bacterial cells and extracellular material which usually have thicknesses within the range of about 20-60 microns and more particularly within the range of about 30-50 microns. Such mature biofilms and their characteristic resistance to bactericidal attack are discussed in the aforementioned papers by Vess et al and in papers by Anderson et al, “Effect of Disinfectants on Pseudomonades Colonized on the Interior Surface of PVC Pipes,” American Journal of public Health, Vol. 80, No. 1, pp. 17-21, and Costerton et al, “Microbial Biofilms,” Annual Review of Microbiology, Vol. 49, 1995, pp. 711-745. For example, the paper by Anderson et al, in addressing research on mature biofilms resulting from colonies of Pseudomonas aeruginosa and Pseudomonas pickettii, discusses the survival of biofilm colonies in the presence of various disinfectants ranging from alcohols and aldehydes to quaternary ammonium compounds and halogen-based antiseptics. As discussed there, survivability is attributed to the existence of extra-cellular glycocalyx-like structures which function to protect the embedded bacteria from the action of the antiseptic material. The paper by Costerton et al characterizes mature biofilms as matrix-enclosed bacterial populations which are adherent to each other and/or to surfaces or interfaces. They are described in Costerton et al as being characterized by the production of extensive networks of highly hydrated exopolysaccharides which are characterized as having substantially enhanced resistance to antimicrobial agents. As discussed in Costerton et al, biofilms cells can be characterized as being at least 500 times more resistant to antibacterial agents than free planktonic cells.

A distinction must be drawn between disinfection and biofilm removal. Biofilm removal includes disinfection, but disinfection does not include biofilm removal. Thus, methods described herein as simply disinfection methods are distinguished from the present invention; simple disinfectants do not remove biofilm and are inherently inferior to methods that do remove biofilm. Methods utilized to eliminate bacterial biofilms in industry include steam purging and hyperchlorination “shock treatments.” In dentistry, hyperchlorination “shock treatments” have been used, but the “shock treatments” must be repeated every week because the biofilm is not removed and it begins to regrow in that period of time. This type of system also requires use of only sterile water to slow down the biofilm formation. According to J. F. Williams, et al, in “Microbial Contamination of Dental Unit Waterlines: Prevalence, Intensity and Microbiological Characteristics,” The Journal of the American Dental Association, Vol. 124, No. 10, 1993, mature biofilms are notoriously resistant to chemical disinfection including these “shock treatments.” Thus, if a practitioner does not treat his system for several weeks, the biofilm will become resistant to this method. According to the aforementioned paper by Vess et al, most biocidal agents have not been shown to destroy a mature biofilm.

It has been suggested to use sterile water, to drain the fresh water lines during periods of non-use or to use filters to catch the microorganisms. However, none of those methods have been shown to effectively remedy the microorganism proliferation for any length of time. The general principles of disinfection are described by Russell, A. D. et al. Principles of Disinfection, Preservation and Sterilization, 3rd ed. Blackwell Science (1999). In more specialized disinfection art, it is known to use disinfectants such as povidone-iodine at a concentration of approximately 10% to reduce the number of microorganisms in small diameter water lines. It is further also known that a mixture of mandelic and lactic acids reduce the number of sensitive microorganisms in contaminated catheters. However, such disinfection is somewhat superficial since it fails to effectively attack and destroy the microorganisms found in the biofilm.

Consequently, the disinfection effect is short-lived. After 24 hours of treatment with povidone-iodine, the number of bacteria is greatly reduced but quickly begins to rise after eight days.

It is also known to use a detergent such as polyoxyethylene sorbitan monooleate (Tween 80™) at approximately 4% concentration to dislodge biofilm from small diameter water lines used in dental equipment. The use of detergent alone, however, does not effectively destroy the microorganism population.

It is also known to use a composition comprising 5% (w/v) hydrogen peroxide, 1% (w/v) ethylenediamine tetraacetic acid (EDTA), and 2% (w/v) sodium dodecyl sulfate (SDS) for decontaminating surfaces that are susceptible to contamination by microorganisms and that are susceptible to the formation of a biofilm coating thereon.

It also known to use a composition comprising 5% (w/v) hydrogen peroxide, 1% (w/v) ethylenediamine tetraacetic acid (EDTA), 2% (w/v) sodium dodecyl sulfate (SDS), and 1% (w/v) peracetic acid for decontaminating surfaces that are susceptible to contamination by microorganisms and that are susceptible to the formation of a biofilm coating thereon.

It also known to use a composition comprising 5% (w/v) hydrogen peroxide, 1% (w/v) ethylenediamine tetraacetic acid (EDTA), 2% (w/v) sodium dodecyl sulfate (SDS), 1% (w/v) peracetic acid, 1% (w/v) lactic acid, 1% (w/v) mandelic acid, 0.1% (w/v) cethylpyridinium chloride, and 1% (w/v) peracetic acid for decontaminating surfaces that are susceptible to contamination by microorganisms and that are susceptible to the formation of a biofilm coating thereon.

The commercially available antiseptics listed in Table 1 have been tested and none of them have shown any efficient decontaminating activity against a biofilm.

TABLE 1
Commercially available antiseptics that do not show any efficient
decontaminating activity against a biofilm (disclosed in U.S. Pat. Nos.
5,759,970 and 5,731,275 issued to Prevost, et al.)

| NAME OR MARK | COMPOSITION |
|---|---|
| BIOVAC ™ | (0.8%) Chlorohexidine, 3.20% EDTA, proteolytic |
| | enzymes, a dispersing agent). |
| EFFERDENT ™ | (Potassium monopersulfate, sodium borate, sodium |
| | lauryl persulfate, sodium bicarbonate, magnesium |
| | stearate, simethicone). |
| POLYDENT ™ | (Potassium monopersulfate, tetrasodium |
| | pyrophosphate, sodium bicarbonate, sodium borate). |
| STERISOL ™ | (Chlorohexidine, glycerol, 38-F, alcohol). |
| THERASOL ™ | (C-31G, NaF, glycerine, alcohol). |
| GLUTARALDEHYDE | Self-descriptive |
| ALCOHOL 70% | Self-descriptive |
| PATHEX ™ | (Phenolic) |
| SODIUM HYPOCHLORITE: 2% | Self-descriptive |

Some methods of decontamination, those described in U.S. Pat. No. 5,837,204, 5,709,546, and 5,526,841 for example, require that chemical products remain in or attached to the water line permanently. Some systems actually require that the decontaminating agents be released into the water during use of the DUWL, for example the iodine releasing cartridge described in U.S. Pat. No. 5,556,279 and the citric acid described in U.S. Pat. No. 5,709,546. Such methods require high levels of caution and regulation due to the possible exposure of patients to hazardous conditions caused by the decontamination method. Even a product that is claimed to be non-leaching, for example the one described in U.S. Pat. No. 5,849,311, must meet a high standard of proof for those claims before being used in contact with human patients. Moreover, despite the increased exposure to chemical agents that these continuous release methods engender, they do not remove biofilm.

In addition, products used in some methods may leave a residue that may be released into the water and contact a patient, even after the line has been flushed. Products used in some methods may react with components of the water line to produce a reactant that may be toxic. Moreover, the laminar flow of water through tubing ensures that the layer of water immediately in contact with the biofilm is stationary, and therefore continuous flush periods do nothing to reduce or disrupt the biofilm (Williams, The Journal of the American Dental Association, Vol. 124, No. 10, 1993).

Other methods require the use of sterile solutions and aseptic technique by the dental personnel responsible for maintaining the equipment. The A-DEC™ clean water system, for example, utilizes a separate sterile water reservoir designed to isolate unit water from community water supplies. Nevertheless, Williams et al also noted that they found gross contamination of samples collected from lines connected to sterile water reservoirs. The USAF Dental Investigation Service (Armstrong Laboratory, Brooks AFB, Tex. 78235-5301) evaluated the A-DEC™ system and produced a Technical Evaluation Project Report, Project #90-54 dated Mar. 11, 1992.

Other methods use ozonated water as a cleaning agent for dialysis units instead of using cleaning solutions. It is claimed in U.S. Pat. No. 5,853,014 issued to Rosenauer Dec. 29, 1998 that ozonated water disinfects and cleans quickly and without leaving any residue. Ozonated water however, is not known to remove biofilm. Its use also requires complex ozone generating equipment and the presence of ozone gas, a substance which could prove harmful to the equipment operators, even if it is generated only when no patients are present.

Other methods may require diluting or mixing a product immediately prior to application. For example, methods that use peroxidase or other enzymes are maintained inactive until admixed in a defined proportion with water. See U.S. Pat. No. 5,419,902, 5,629,024, an†

Other methods would require disassembly of the water lines for immersion in a decontamination chamber, as disclosed in U.S. Pat. No. 5,772,971.

Claims have been made in U.S. Pat No. 5,709,546 that a solution of citric acid (0.117 wt. %) was effective in inactivating an established biofilm comprised of Pseudomonas aeruginosa. A culture of pseudomonas nevertheless bears little relationship to a naturally acquired water line biofilm. Such a simple culture is an inappropriate challenge for a product that is claimed to remove a naturally acquired biofilm community. As previously described, a biofilm is a complex sessile community of specifically coaggregated organisms whose members have co-evolved to promote their mutual survival. Thus, an artificial culture of a single, or even a multiplicity of organisms, would not respond to treatment as would a naturally acquired community. This is apparent from considering the work of Costerton et al (1999), cited previously. Costerton notes that biofilms contain differentiated structures that include channels in which nutrients can circulate, and patterns of gene expression that vary between regions. This level of complexity approximates the organization of tissues found in higher organisms. The simple pseudomonas culture described in the '546 patent would be a poor model for such a complex community. The inadequecy of a pseudomonas culture as a biofilm model is also demonstrated by U.S. Pat. No. 5,928,889 issued to Bakich , et al. Jul. 27, 1999, This invention provides a methodology for simulating natural biofilm. The invention is said to have utility for the testing of formulated product activity for inhibition or removal of the simulated natural biofilm, thereby providing a reliable indicator of the relative activity of the products under natural environmental conditions. In addition, as described above, the '546 method requires the continuous use of citric acid, an undesirable condition.

U.S. Pat. No. 5,928,889 issued to Bakich , et al. Jul. 27, 1999, provides a methodology for simulating natural biofilm. The invention is said to have utility for the testing of formulated product activity for inhibition or removal of the simulated natural biofilm, thereby providing a reliable indicator of the relative activity of the products under natural environmental conditions.

Accordingly there remains a need for a composition and a method for decontaminating small diameter water lines for medical and dental equipment which will effectively dislodge and eliminate a biofilm and at the same time destroy the microorganism flora in the fresh water and in the dislodged biofilm. In addition the composition or method should not corrode water line materials, should be safe and non-toxic, should not expose patients to the decontaminaiting chemicals or process, should not leave significant residual chemicals in the water line, should not require the use of sterile solutions and aseptic technique by dental personel, and should not require mixing or dilution of chemicals prior to use.

### SUMMARY OF THE INVENTION

The formulation of the present invention is a simple one and, in the preferred embodiment, includes a composition which, for each liter of water, includes approximately 0.25 g sodium iodide, 1.6 g citric acid, 0.8 g sodium persulfate, and 0.03 g sodium percarbonate For the purposes of the present disclosure, an acronym (CIPP) plus a number, (225) designates the composition of the foregoing formula. Thus the composition is referred to as CIPP225 . After extensive testing and analysis, the above formulation, when used as shown in the following examples, more effectively than any known alternative method, not only prevented, but removed existing biofilm from medical unit water lines, and afforded an unrivaled degree of decontamination of such water lines. Although the invention is described herein with reference to specific embodiments, this description is not meant to be construed in a limited sense. For example, dental unit water lines (DUWL) have been chosen as an exemplary subject for application of the invention. Nevertheless, any small water lines, particularly small water lines that are part of a medical apparatus are suitable subjects for the invention. Preferably the medical unit water line has a maximum inner diameter of approximately 3.5 mm. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

Extensive testing of the use of the above formulation to decontaminate small diameter water lines for dental equipment shows that its use does not corrode DUWL materials; it is safe and non-toxic; it does not expose patients to the decontaminaiting chemicals or process; it does not leave significant residual chemicals in the water line; it does not elute cytotoxic chemicals from DUWLS; and it does not require mixing or dilution of chemicals prior to use.

Safety and toxicity testing of CIPP225 show that CIPP225 is not toxic, irritating, or sensitizing. CIPP225 was also subjected to corrosion tests on materials commonly used in DUWL. All changes observed in CIPP225-exposed material were minor and similar to those observed for materials soaked in tap water. Tests further show that CIPP225 is effective in removing established biofilms. This is a surprising result because it is well accepted that established biofilms are resistant to disinfection.

### BRIEF DESCRIPTION OF THE DRAWINGS

The above objects and other advantages of the present invention will be clarified by reference to the accompanying drawings in which:

FIG. 1 is scanning electron micrograph depicting an untreated DUWL clipping from a private dental office.

FIG. 2 is a scanning electron micrograph depicting a DUWL clipping from a private dental office after its treatment with CIPP225.

### DETAILED DESCRIPTION OF THE INVENTION

Certain aspects of the present invention are described in greater detail in the non-limiting examples that follow. Some of the results of the following studies have been published, as cited below. Enabling support for the invention, however, was not disclosed in these publications.

In the following examples the composition of CIPP-225 includes, for each liter of water, 0.245 g sodium iodide, 1.57 g citric acid, 0.7939 g sodium persulfate, and 0.03297 g sodium percarbonate.

### EXAMPLE 1.

Purpose: Two independent studies were performed to compare the efficacy of CIPP225 and bleach disinfection of DUWL. The objective of these studies was to compare the application of the present invention to the application of bleach. The A-DEC™ clean water system utilizes a separate water reservoir designed to isolate unit water from community water supplies. The manufacturer recommends that the system be flushed once a week with a solution of 1% sodium hypochlorite to control formation of microbial biofilms.

### Microbiology Methods

### Heterotrophic Plate Counts

Water samples are collected from the handpiece (HP) and syringe (SY) of test dental units into sterile vials following the principles of aseptic technique.

Water samples are maintained at 4° C. and processed within 24 hours of collection.

Samples are plated (spread plate method) in triplicate on R2A agar supplemented with 0.1% sodium thiosulfate (to neutralize any residual CIPP225). Endpoint counts are determined by plating a range of dilutions prepared in sterile water.

Plates are incubated at 25±2° C. for 7 days. Counts are determined and averaged for each sample.

1) UTHSCSA Dental School Clinic Study: Waterlines from ten dental units were evaluated for 24 weeks. Waterlines in 5 dental units equipped with CIPP225 Delivery Systems were treated with CIPP225 overnight on a daily basis. After treatment, lines were flushed with tap water for two minutes to remove residual CIPP225 from the lines. CIPP225 did not come into contact with patients and was used at the end of the day after all patients were seen. Tap water was used for these units. The remaining 5 units were equipped with A-DEC's™ Self-contained Water Systems and treated weekly with 1:10 diluted household bleach (0.525% sodium hypochlorite ˜5000 ppm free chlorine). Additionally, a solution of tap water containing ˜3 ppm free chlorine was continuously used during patient treatments. Water samples (˜5 ml) were collected weekly for 24 weeks (n=120) from the handpiece of each DUWL and plated on R2A agar to determine CFU/ml. Over the entire 24 weeks, 91% of samples from units treated with CIPP225 were ≦200 CFU/ml while only 62% from bleach-treated units were ≦200 CFU/ml. In the last 12 weeks of the study, 97%.of samples from units treated with CIPP225 were ≦200 CFU/ml while 43% from the bleach-treated units were ≦200 CFU/ml. In conclusion, the use of the composition of the present invention appears to be more effective than bleach in maintaining ≦200 CFU/ml of aerobic mesophilic heterotrophic bacteria in DUWL. This study has been published in Warren et al., 1999 OSAP Annual Symposium, Infection Control Integration, Jun. 24-27, 1999, Cincinnati, Ohio; and in Warren et al. Journal of Dental Research, 1999, Vol. 78, Special Issue, Abstracts of Papers, #1253, p. 262, 77th General Session of the International Association for Dental Research, Mar. 10-13,;1999, Vancouver, British Columbia, Canada.

2) Navy Dental Clinic Study. Six dental units equipped with free-standing water reservoirs were evaluated for 16 weeks. All units had previously been treated weekly with a 1:10 solution of bleach. At the beginning of this study, baseline water samples were collected, and units were assigned for either CIPP225 (5 units) or bleach (1 unit) treatment. As above, CIPP225 units were treated overnight on a daily basis. After treatment, lines were flushed with tap water for two minutes to remove residual CIPP225. Also in this study, CIPP225 did not come into contact with patients and tap water was used for routine use. The bleach unit continued to receive weekly treatments with 1:10 diluted bleach. All treatments and sample collections were performed by the Navy dental professionals. Water samples (also ˜5 ml) were collected on a regular basis for 16 weeks from the handpiece and syringe of each DUWL and plated on R2A agar to determine total aerobic CFU/ml. During the 16 weeks of the Navy Dental Clinic Study, 92% of handpiece and 88% of syringe samples from CIPP225-treated units were ≦200 CFU/ml compared to only 20% of handpiece and 0% of syringe samples from bleach treated units. This study has been published in Warren et al., 1999 OSAP Annual Symposium, Infection Control Integration, Jun. 24-27, 1999, Cincinnati, Ohio. Similar studies were conducted in other dental offices with similar results. The results of all studies are summarized Table 2.

TABLE 2
(% ≦200 cfu/ml)

| | Handpiece | | Syringe | |
|---|---|---|---|---|
| CLINIC: | Dentacide | Bleach | Dentacide | Bleach |
| UTHSCSA (WEEKS 1-24) | 91 | 62 | 83 | 81 |
| UTHSCSA (WEEKS 13-24) | 97 | 43 | 90 | 73 |
| CORPUS CHRISTI (28 week | 93 | 38 | | |
| duration) | | | | |
| INGLESIDE (20 week | 86 | 43 | 90 | 14 |
| duration) | | | | |

Bacterial levels found in handpieces and syringes after 20-28 weeks treatment with dentacide or bleach.

### EXAMPLE 2

In this study, ten lines were treated every weekend with CIPP225; lines in 6 of the units were also treated nightly. After treatment, lines were flushed to remove residual CIPP225; tap water was used for routine operation. Five untreated DUWL were used as controls. Samples (˜3 ml) were collected weekly for 10 weeks and quantified for total mean colony forming units (CFUs)/ml of water by culture on R2A agar at 25% C. for 3 weeks. Results (expressed as the mean CFUs/ml [±S.E.M.]) at 4 weeks were 8.33 (±6.5) for nightly-treated DUWL, 209.25 (±119.8) for weekly-treated, and 1.86×105 (±0.45) for untreated; results at 8 weeks were 105.83 (±64.2) for nightly-treated, 1.06×104 (±0.68) for weekly-treated, and 1.2×106 (±0.45) for untreated. Mean CFUs/ml were significantly lower in samples from daily-treated DUWL vs. weekly-treated (P=0.06) and untreated (P=0.001). DUWL clippings, processed for scanning electron microscopy, demonstrated that mature biofilm was comprised of multi-layered microcolonies including: curved rods, cocci, hyphae, spirochetes and matrix material. Images of biofilm in DUWL clippings from untreated lines and of clipplings from treated lines show that CIPP225 treatment successfully removed the biofilm, leaving behind the remnants of dead cells and cellular debris but little to no matrix material. In conclusion, CIPP225 appears to be effective for use in preventing the development of microbial biofilm in DUWL, as well as, removing preexistent biofilm from waterlines. This study has been published in Sanford et al., 1998 OSAP Annual Symposium, Abstract 9809, and in Sanford et al, Journal of Dental Research, 1999, Vol. 78, Special Issue, Abstracts of Papers, #1248, p. 261, 77th General Session of the International Association for Dental Research, Mar. 10-13, 1999, Vancouver, British Columbia, Canada.

### EXAMPLE 3

### Purpose

In this study CIPP225 was tested for the capacity to to reduce bacterial counts, eliminate biofilm, and prevent recolonization and reformation of biofilm in the waterlines of dental units equipped with independent water reservoirs.

Methods: Six dental units in five private dental offices were equipped with independent water reservoirs. Using this system, waterlines were treated overnight on a daily basis with CIPP225. After treatment, lines were flushed with tap water to remove residual CIPP225. CIPP225 did not come into contact with patients, and tap water was used for routine operation. Disinfection of DUWL with CIPP225 was performed by the dental professionals in each office according to a standard procedure. Quantification: Water samples (3-5 ml) were collected from the handpiece and syringe of each unit on a regular basis for up to 16 weeks. Samples were quantified for total mean CFUs/ml of water by triplicate culture on R2A agar at 25(C. for 7 days. Scanning Electron Microscopy (SEM): DUWL clippings (1 cm) were fixed in 2% giutaraldehyde in 0.2 M cacodylate-HCL, dehydrated, sputter coated with gold-palladium and examined with a LEO 435VP scanning electron microscope.

Results: Baseline water samples of the evaluated DUWLs demonstrated a mean count of ˜2,000,000 CFU/ml. Disinfection of DUWL with CIPP225 dramatically reduced cultivable bacteria by 5-6 logs, and with one exception, to <100 CFU/ml. SEMs of untreated DUWLs demonstrated mature biofilm comprised of multi-layered microcolonies including: curved rods, cocci, spirochetes and matrix material. Images of biofilm from the treated and untreated DUWLs are shown in FIG. 1 and FIG. 2, respectively. This study has been published in Sanford et al, 1999 OSAP Annual Symposium Infection Control Integration, June 24-27, 1999, Cincinnati, Ohio.

### EXAMPLE 4.

### Reduced Treatment Study.

In study similar to that described in Example 1 was performed comparing three CIPP225 treatment frequencies: daily, twice weekly, and weekly. As depicted in FIG. 3, the number of samples containing high bacterial levels increases as the treatment frequency declines.

### EXAMPLE 5

This study evaluated a microbicidal anti-biofilm treatment, CIPP225, for its potential to adversely affect the plastic, rubber, and metal components in a dental unit.

Methods: Representative components of typical dental units (A-DEC™) were exposed to three test isolutions: tap water (normal usage), CIPP225 at its recommended concentration (1×), and ten times recommended concentration (10×). Continuous exposure and 10×were used to accelerate environmental conditions. The viscoelastic properties of non-metal components were evaluated for changes as a function of exposure time and solution environment. Several sizes of polyurethane (PU) and PVC dental unit tubing were each cut into five 50 cm samples and placed in a test solution.

After zero, 2, 4, and 6-month, 5 cm specimens were cut from each sample and stressed in tension (ASTM D638-91), and then evaluated using a universal mechanical tester (Instron Model 1125). Similarly, individual PU gaskets were tested in tension and polyethylene-propylene ‘O’ rings were tested in compression. One way ANOVA was used to determine differences within each component group (n=5, p(0.05) due to environment, CIPP225 concentration, exposure time and the interaction of concentration×time. Pairwise comparisons were made within groups having significant differences using the Student-Newman-Keuls method. Analyses were carried out using SigmaStatT™ version 1.01, statistical software (Jandel).

A separate test to assess corrosion resistance of metal components was also performed. A new routing manifold block was installed in each of two dental units and treated daily with CIPP225 or with NaOCl bleach through a combination of weekly and continuous treatments. After 6-month, the blocks were removed, disassembled, and inspected under low power magnification (10 to 20×) for corrosion. An unexposed manifold block was used as a control.

Results: In tap water, modulus (relative stiffness) tended to decrease slightly for all materials except for the flexible PVC syringe tubing. This was likely due to water absorption and softening. A decrease in modulus was always accompanied by reduced stress at yield and at break, and increased elongation; thus indicating that the materials became somewhat more elastic. For several materials, most notably the clear PU supply tubing, these changes either ceased or reversed after 4 -6-month. Such behavior is often caused by the absorption of water by a plasticized material that is followed by gradual extraction of the plasticizer. For the PVC syringe tubing, modulus increased slightly during the first four months and then remained approximately constant, with accompanying increases in stress at yield and at break, and reduced elongation. This syringe tubing is a highly plasticized PVC. Thus, increased modulus indicates that plasticizer extraction dominates water softening. In the presence of CIPP225, effects similar to those in water were seen. Some property changes were somewhat exaggerated compared to water, while others were reduced depending on the component's composition. In general, changes in modulus, stress to yield, etc. are dependent on exposure time, CIPP225 concentration and concentration×time. However, all of these changes are small and most are significant only at 10×CIPP225 concentration after the longest exposure time (6-month). In the corrosion resistance study, some corrosion was observed in both treatments. However, the sample treated with bleach experienced more severe crevice attack than the sample treated with CIPP225 in large dental clinics.

Conclusion: Given the accelerated exposure conditions, the observed changes are small and we conclude that no practical adverse effects due to CIPP225 treatment should be expected over the normal, approximately 5 year, lifetime of these rubber and plastic components. Similarly, CIPP225 is not expected to adversely affect metal components in the water circulating system of dental units and should be less corrosive than bleach. This study has been published in Siegel, G., et al. 1999 OSAP Annual Symposium Infection Control Integration, Jun. 24-27, 1999, Cincinnati, Ohio.

### EXAMPLE 6

### Cytotoxicity Elution Tests

Definitions of terms used in the cytoxicity elution test are provided here. Positive control: Sterile 1 cm² filter paper saturated with 500 ppm cadmium solution. Negative control: Sterile USP negative bioreaction reference standard high-density polyethylene. Reagent control: Reagent solutions unexposed to positive control, negative control or experimental sample.

### Procedure

The following procedure was used for a 12-month treatment of dental waterline polyurethane tubing. Similar procedures were used for 3-month and 6-month treatments. Test material: 39.02 cm² of dental waterline polyurethane tubing.

39.02 cm² of test material consisting of the internal surface area of the tubing was filled to capacity with 3.5 ml of serum supplemented culture medium, clamped off with hemostats, and incubated for 24 hours at 37°±1° C. with 4%-6% Co₂. 60 cm² of positive control material was extracted in 20 ml of medium and 30 cm² of negative control material was extracted in 10 ml of medium under the same extraction conditions. A reagent control was also prepared.

Following incubation, the test sample extract was removed and brought up to the calculated volume of 13.0 ml by adding 9.5 ml of MEM. Tissue culture dishes containing a monolayer of L-929 mouse fibroblast cells were exposed in triplicate to the diluted test sample extract, positive and negative control extracts, and a MEM reagent control. All cell cultures were incubated at 37° C. with 4-6% CO₂. The cells were examined microscopically at 24 and 48 hours for cytotoxic response.

All dishes were scored at each examination period using the USP 23 standards. A complete description of the relevant USP standards is available from the United States Pharmacopeia Convention, Inc., 12601 Twinbrook Parkway, Rockville, Md. 20852. These requirements, published in USP 23, are shown in shown in Table 3.

TABLE 3
Reactivity Grades for Elution Test

| Grade | Reactivity | Conditions of All Cultures |
|---|---|---|
| 0 | None | Discrete intracytoplasmic granules; no cell lysis |
| 1 | Slight | Not more than 20% of the cells are round, |
| | | loosely attached, and without intracytoplasmic |
| | | granules; occasional lysed cells are present. |
| 2 | Mild | Not more than 50% of the cells are round and |
| | | devoid of intracytoplasmic granules; no extensive |
| | | cell lysis or empty areas between cells. |
| 3 | Moderate | Not more than 70% of the cell layers contain |
| | | rounded cells and/or lysed. |
| 4 | Severe | Nearly complete destruction of the cell layers. |

Interpretation: The sample meets the requirements of the test if the cell culture treated with the sample extract does not score greater than a Mild Reactivity (Grade 2).

The average of the 48 hour results of the three test dishes from each sample was used to determine the cytotoxic response.

Interpretation: The sample meets the requirements of the test if the cell culture treated with the sample does not score greater than a Mild Reactivity (Grade 2).

### Results

The results of the 12-month cytotoxicity elution test are shown in Table 4.

TABLE 4

| | Reactivity | | |
|---|---|---|---|
| Test Item | Plate 1 | Plate 2 | Plate 3 |
| Dental Waterline Tubing - Polyurethane | Slight | Slight | Slight |
| Positive Control | Severe | Severe | Moderate |
| Negative Control | None | None | None |
| Reagent Control | None | None | None |

### Conclusion

This sample meets the requirements of USP 23 and ISO 10993-5 (from the International Organization for Standardization) “Biological evaluation of medical devices—Part 5: Tests for in vitro cytotoxicity”, for this cytotoxity test.

Similar studies conducted with shorter daily treatments (3 months and 6 months) of polyurethane tubing also met the requirements of USP 23 AND iso 10993-5 cytotoxicity test.

Similar tests were performed substituting dental waterline silicon tubing for polyurethane tubing. The results of a 12-month daily exposure are shown in Table 5.

TABLE 5

| | Reactivity | | |
|---|---|---|---|
| Test Item | Plate 1 | Plate 2 | Plate 3 |
| Dental Waterline Tubing - Silicone | Slight | None | Slight |
| Positive Control | Severe | Severe | Moderate |
| Negative Control | None | None | None |
| Reagent Control | None | None | None |

### Conclusion

This sample meets the requirements of USP 23 and ISO 10993-5 for this cytotoxity test.

Similar studies conducted with shorter daily treatments of silicone tubing (3 months and 6 months) also met the requirements of USP 23 AND iso 10993-5 cytotoxicity test.

A similar cytotoxicity-elution test for was conducted on CIPP225-treated (3-month daily exposure) plasticized polyvinyl chloride dental unit waterline tubing

### Procedure

The treated (experimental) tubing, measuring 38.2 cm² in internal surface area, was filled to holding capacity with 3.47 ml of serum supplemented culture medium. The untreated (control) tubing, measuring 36.3 cm² in internal surface area, was filled to holding capacity with 3.78 ml of serum supplemented culture medium. The tubing ends were clamped and the samples were incubated for 24 hours at 37%±1% C. with 4%-6% CO₂. Two positive controls were extracted in 15 ml of medium and 30 cm² of negative control material was extracted in 10 ml of medium under the same extraction conditions as the test samples. A reagent control was also prepared. Upon completion of the 24 hour extraction period. the treated and untreated tubing samples were drained and the extract brought up to the appropriate volume with MEM. The treated (experimental) tubing yielded 3.2 ml of composite extract and was diluted with 9.5 ml of MEM to obtain a total volume of 12.7 ml of extract. The untreated (control) tubing yielded 12.9 ml of composited extract and was diluted with 9.2 ml of MEM to obtain a total volume of 12.1 ml of extract.

Tissue culture dishes containing a monolayer of L-929 mouse fibroblast cells were exposed in triplicate to the test samples, positive and negative control extracts, and a MEM reagent control. All cell cultures were incubated at 37% C.±1% C. with 4-6% CO₂. The cells were examined microscopically at 24 and 48 hours for cytotoxic response.

At the 48 hour observation period, the (untreated) control sample plates were stained to verify cell reactivity using Trypan blue stain. The plates were rinsed with Hanks balanced salt solution to remove excess stain before the percent reactivity was calculated.

All dishes were scored at each examination period using the USP 23 Table ( A complete description of the relevant USP standards is available from the United States Pharmacopeia Convention, Inc., 12601 Twinbrook Parkway, Rockville, Md. 20852. These requirements, published in USP 23, are shown in shown in Table 3.)

Interpretation: The sample meets the requirements of the test if the cell culture treated with the sample extract does not score greater than a Mild Reactivity (Grade 2).

Results of the test are shown in Table 6

TABLE 6

| Test Item | Reactivity |
|---|---|
| Dental Waterline Tubing - Plasticized Polyvinyl Chloride, Teated (experimental) | Moderate |
| Dental Waterline Tubing - Plasticized Polyvinyl Chloride, Untreated (control) | *Moderate |
| Positive Control | Severe |
| Negative Control | None |
| Reagent Control | None |

*The percent reactivity was calculated on the control samples using NV SOP 15A-08. Over 100 cells were counted in 3 random locations on each replicate plate. The average reactivity was calculated by dividing the number of reacting cells (designated by attaining stain) into the total number of cells (both stained and unstained). The reactivity of the 3 locations was averaged to provide the mean percent reactivity per replicate. The results of the three replicates are shown in Table 7.

TABLE 7
Percent reactivity of control samples from Table 6.

| Untreated (Control) | Mean Percent | |
|---|---|---|
| Sample Number | Reactivity | Reactivity |
| 1 | 69.5% | Severe |
| 2 | 54.9% | Moderate |
| 3 | 51.0% | Moderate |

The sample reactivity of the three replicates were averaged to obtain the final reactivity of moderate.

### Conclusion

Neither the treated nor the untreated PVC Dental Waterline Tubing meet the requirements of USP 23 or ISO 10993-5 for this cytotoxicity test.

### EXAMPLE 7

### Primary Eye Irritation Test

### Procedure

Both eyes of six Albino rabbits were examined for eye defects and irritation within 24 hours prior to testing. The right eye of each animal was dosed with 0.1 ml of undiluted CIPP225, while the left was untreated to serve as a control. Eyes were examined and grade of ocular reaction was recorded at 24, 48 and 72 hours after application. The eyes were examined for evidence of corneal ulceration or opacity, inflammation of the iris, redness and chemosis of the conjunctiva. Scores of 2 or greater indicate a positive reaction. If only one animal exhibits a positive reaction, the test is regarded as negative.

Table 8 Scale for scoring ocular lesion. Scale adopted from Draize, J. H., “The Appraisal of the Safety of Chemicals in Food, Drugs, and Cosmetics-Dermal Toxicity,” Association of Food and Drug Officials of the United States, Topeka, Kans. (1965). ² 16 CFR Part 1500.42, Jan. 11, 1995. ³Positive reactions are starred.

TABLE 8

| Observation | Value³ |
|---|---|
| Cornea ulceration | |
| No ulceration | 0 |
| Fine stippling | 1 |
| Any ulceration greater than fine stippling | 2* |
| Cornea opacity- degree of density (area most dense taken for reading) | |
| No opacity | 0 |
| Scattered or diffuse area, details of iris clearly visible (only slight dulling of normal | 1 |
| luster) | |
| Easily discernible translucent areas, details of iris slightly obscured | 2* |
| Opalescent areas, no details of iris visible, size of pupil barely discernible | 3* |
| Opaque, iris invisible | 4* |
| Iris | |
| Normal | 0 |
| Folds slightly above normal, congestion, swelling, slight circumcorneal injection, (any | 1 |
| or all of these or any combination thereof); iris still reacting to light (sluggish reaction | |
| is positive) | |
| No reaction to light, hemorrhage, gross destruction | 2* |
| Conjuctivae: redness of palpebral and bulbar conjunctivae, excluding cornea and iris | |
| Vessels normal | 0 |
| Vessels definitely injected above normal | 1 |
| More diffuse, deeper crimson red, individual vessels not easily discernible | 2* |
| Diffuse beefy red | 3* |
| Chemosis | |
| No swelling | 0 |
| Any swelling above normal (includes nictitating membrane | 1 |
| Obvious swelling with partial eversion of lids | 2* |
| Swelling with lids about half closed | 3* |
| Swelling with lids about half closed to completely closed | 4* |

### RESULTS

The ocular irritation scores were 0 for five animals. One animal scored 1 for redness in both the left (control) and right (test) eye at 72 hours.

### Conclusion

CIPP226 is classified as non-irritating to eyes.

### EXAMPLE 8

### Primary Dermal Irritation

### Procedure

The procedure was adapted from Draize, J. H., “The Appraisal of Chemicals in Food, Drugs, and Cosmetics.” Dermal Toxicity, pp. 45-49. Association of Food and Drug Officials of the United States, Topeka, Kans. (1965).

The backs of six Albino rabbits were clipped free of hair and examined for healthy, intact skin within 24 hours prior to testing. One intact and one abraded site (prepared by disrupting the stratum corneum) was dosed with 0.5 ml of CIPP225, covered with 1-in gauze patches and wrapped with impervious material. Test sites were uncovered after 24 hours, examined and scored (0 for no erythema/edema to 4 for severe erythema/edema). Sites were also scored at 72 hours after application. Based on the scores, a Mean Primary Irritation Index was calculated and any reaction is assigned a descriptive rating, from the Index, for degree of irritation (0 for non-irritating to/E6 for severely irritating; see 16 CFR Part 1500.41).

### Results

All test sites scored 0 for all time points and thus, CIPP225 was assigned a Mean Primary Irritation Score of 0.

### Conclusion

CIPP225 is classified as non-irritating to the skin.

### EXAMPLE 9

### Cytotoxicity—Agar Diffusion

### Procedure

Plates were prepared with a solidified agar layer overa confluent monolayer of L-929 mouse fibroblast cells. Triplicate test samples were prepared by saturating 1 cm² pieces of sterile filter paper with CIPP 225. The samples were then placed on the agar layer of separate cell culture dishes. Three positive controls and three negative controls were placed on the agar layer in the same manner as the test samples. All cultures were incubated for 24 hrs at 37% C. with 4-6% CO₂. After incubation, the cells were examined microscopically for cytotoxic response.

### Scoring

All dishes were scored using the USP 23 standards shown in Table 9.

TABLE 9
Reactivity Grades for Agar Diffusion Test

| Grade | Reactivity | Conditions of All Cultures |
|---|---|---|
| 0 | None | No detectable zone around or under specimen. |
| 1 | Slight | Some malformed or degenerated cells under |
| | | specimen. |
| 2 | Mild | Zone limited to area under specimen |
| 3 | Moderate | Zone extends 0.5 to 1.0 cm beyond specimen. |
| 4 | Severe | Zone extends greater than 1.0 cm beyond specimen |
| | | but does not involve entire dish. |

Results of the agar diffusion test are shown in Table 10

TABLE 10

| Test Item | Reactivity |
|---|---|
| CIPP 225 | Slight |
| Positive Control | Severe |
| Negative Control | None |

CIPP225 showed slight reactivity (score 1), indicating some malformed cells. These results meet the requirements of the USP test for cytotoxicity.

### Conclusion

CIPP 225 performs in an acceptable range for cytotoxicity.

### EXAMPLE 10

### Dermal Sensitization

The study design and study schedule are summarized in Table 11 and Table 12 Forty-six Hartley albino guinea pigs were used. These included twenty test animals and eight positive controls. In the Challenge Phase, a group of ten naive animals were dosed with the same material as the test group and another eight naive animals were dosed with the same material as the test group and another eight naive animals were dosed with the same solution as the positive controls. The positive control tests were performed as a historical study.

The test material was administered undiluted. A positive control solution of dinitrochlorobenzene (DNCB) was dosed as a solution in 9.5% aqueous ethanol.

In the induction phase, the test group received three six-hour exposures to 0.3 ml volumes of the test material. The positive control group received 3 exposures to a 0.1% solution of DNCB. These were given on Days 0,7, and 14. In these exposures, 0.3 ml volumes of DNCB applied on Hill Top™ chambers and the test material, were applied to shaved skin sites on the right side of the animal. To protect the test |material, animals, trunks were wrapped with gauze held in place with ½ inch masking tape. The test material was removed after six hours. Twenty-four hours after each exposure, the sites ere scored for erythema and edema. The third dose was moved to a previously unexposed site on the right side in cases where excessive irritation was seen.

In the challenge phase, performed 14 days after the last induction exposure, the test material and positive control solution were administered in the same manner as in the induction exposures, but to a previously unexposed site on the left side of each animal. After a six hour exposure, the test material was removed. The sites were scored 24 and 48 hours after the dose application.

TABLE 11
Study
Design

| | INDUCTION PHASE EXPOSURES | | | | CHALLENGE | | | |
|---|---|---|---|---|---|---|---|---|
| | Number of | Concen- | Duration | | No. | Concen- | Duration | |
| GROUP | Animals | tration | (hrs) | Site | Exposure | tration | (hrs) | Site |
| Test | 20 | 1.0 | 6 | R | 3 | 1.0 | 6 | L |
| Test | 10 | NA | NA | NA | NA | 1.0 | 6 | L |
| Naive | | | | | | | | |
| Control | | | | | | | | |
| Positive | 8 | 0.1 | 6 | R | 3 | 0.025 | 6 | L |
| Control | | | | | | | | |
| Naive | 8 | NA | NA | NA | NA | 0.025 | 6 | L |
| Positive | | | | | | | | |
| Control | | | | | | | | |

R = right flank
L = left flank

TABLE 12
Study Schedule

| Time | Procedure |
|---|---|
| Induction Phase | |
| Day-1 | Test and positive control groups clipped |
| Day 0 | Test and positive control groups shaved and dosed |
| Day 1 | 24-hour post-induction scoring |
| Day 6 | Test and positive control groups clipped |
| Day 7 | Test and positive control groups shaved and dosed |
| Day 8 | 24-hour post-induction scoring |
| Day 13 | Test and positive control groups clipped |
| Day 14 | Test and positive control groups shaved and dosed |
| Day 15 | 24-hour post-induction scoring |
| Primary Challenge | |
| Phase | |
| Day 27 | All groups clipped |
| Day 28 | All groups shaved and dosed |
| Day 29 | 24-hour post-challenge scoring |
| Day 30 | 48-hour post-challenge scoring |

### Procedure

Sample Preparation—For the induction and challenge phases, the test material was administered undiluted, as per the protocol and sponsor request.

The positive control material was weighed and dissolved in 95% ethanol. The ethanol/DNCB solution was then diluted with deionized water to achieve a 9.5% aqueous ethanol solution.

Dosing Procedure—Hair at the dosing site on the flank of each guinea pig was clipped the day before the dosing. On the morning of the test, the dosing sites were shaved. Hill Top Chambers, containing 0.3 ml volumes of the positive control solution, and the test material were applied to the shaved dosing sites for the induction phase and the challenge phase.

After application, the animals were wrapped with gauze, which was held in place with ½ inch masking tape. The animals were then returned to their cages. After six hours, the wrappings and the chambers were removed, and the test sites of the positive control animals were washed with 70% aqueous ethanol to remove any residues.

Scoring—Scoring was done according to the criteria in Table 13. For the induction phase and primary irritancy screens, the animals were scored 24 hours after application of the patches. For the primary challenge phase, they were scored 24 and 48 hours after dose application.

Clinical Observations—During both the induction and challenge phases, all animals were observed at lease once daily for signs of ill health, reaction to treatment or mortality.

Weights—Animals were weighed at the beginning and the end of the study.

Primary Irritancy Screens—As part of the historical positive control study, a primary irritation screen was performed to confirm the dose concentrations for the induction and challenge phases of the study. Four guinea pigs were clipped and shaved as described above. Four concentrations of DNCB (0.1, 0.05, 0.025, and 0.01% weight/volume) were prepared These were applied in 0.3 ml volumes on Hill Top Chambers to shaved sites of the animals as described above. The dosing sites were rotated so that no two animals received the same dose concentration at the same site. The animals were wrapped as described above. They were unwrapped after six hours of exposure. The dosing sites were scored according to the criteria in Table 13

### Induction Phase

Sample Preparation—The test material was administered undiluted.

Dosing Procedure—The test and positive control group animals were dosed and wrapped according to the procedure stated previously. The test group animals were dosed with 0.3 ml of the test material. The eight positive control animals were dosed with 0.3 ml volumes of 0.1% DNCB. Fresh preparations of the positive control solution were used for each exposure.

Six hours after dosing, the animals were unwrapped and marked with a felt pen in order to locate the sites for scoring.

This procedure was repeated on Days 7 and 14. The animals were reshaved prior to each dosing. The doses for the second (Day 7) and for the third day (Day 14) exposures were applied at the same sites as for the first exposure. In cases where scores of 3 were seen at the 24 hour observation, the dose was administered to a new site.

### Challenge Phase

Sample Preparation—The test material was administered undiluted. The challenge dose for the positive control determined in a historical primary irritancy screen, was a 0.025% solution of DNCB in 9.5% aqueous ethanol.

Dosing Procedure—The dosing and wrapping procedures were the same as those used in the induction phase.

Thirteen days after the third induction exposure, the animals were shaved on their left side. The next day, two weeks after the last induction exposure, the dosing sites, at a previously unexposed site on the left side, were shaved with an electric shaver.

The test material and Hill Top Chambers containing 0.3 ml volumes of the control solution were prepared. These were applied to the dosing sites on the test group, positive control, and respective naive control group animals.

Scoring Procedure—Twenty-four hours after dose application, the sites were scored according to the criteria in Table 4. The scoring was repeated 48 hours after application.

### Interpretation and Analysis

Two different scores were calculated to analyze test results. These were determined for both the 24 and 48 hour readings.

The Incidence Score represents the number of animals in each group showing responses of 1 or greater, at either 24 or 48 hours, expressed as a fraction of the total number of animals tested in the group. The highest possible value for the incidence score is 1.0.

The Severity Index is the sum of the test grades for animals in a group, at either 24 or 48 hours, divided by the total number of animals in that group. The highest possible value for the Severity Index is 3.0.

### Results

### Primary Irritancy Screen

Positive Control Group—The results for the dosage selection for DNCB is shown in Table 14. A 0.1% concentration was used for the induction doses based on historical experience. The results of the primary screen confirmed the historical experience. A concentration of 0.1% resulted in a score of 1 (moderate patchy erythema) and a score of 0.5 (slight patchy erythema). At this concentration, no necrosis or permanent damage to the skin was seen. The 0.025% concentration was chosen for the challenge dose. This concentration resulted in one of four animals with a score of 0.5. This was the highest non-irritating concentration and was used to challenge the positive controls.

### Induction Phase

The results of the scoring for the induction phase are shown in Table 15.

Scoring Results—Test Group—After the second induction exposure, two of twenty test group animals presented with a score of 0.5. After the third induction exposure, one of twenty test group animals presented with a score of 0.5. No animal presented with more than one reaction.

Scoring Results—Positive Control Group—After the first exposure, scores ranged from 0 to 0.5. After the second and third exposures, scores ranged from 2 to 3.

### Primary Challenge Phase

Clinical Observations—The animals remained healthy and exhibited no toxic signs during the course of the study.

Scores—The results of the 24 and 48 hour observations are shown in Table 16.

Scoring Results—In the test group, no scores greater than 0.5 were seen. Most animals had no reaction. In the test naive control group, no reaction was seen.

In the positive control group, all eight animals exhibited a score of 2 or greater. In the positive naive control group, no scores greater than 0.5 were seen. At the 24 hour observation, six animals had no reaction. At the 78 hour observation, seven animals had no reaction.

Body Weight—All animals showed normal weight gain during the course of the study.

### Incidence Score and Severity Index

Incidence Score—The incidence scores are shown in Table 17. For the test group and test naive control group, the scores were 0.0 for both the 24 and 48 hours, respectively.

For the positive control, incidence score for 24 hours was 1.0 (100% incidence) and 0.9 (90% incidence) for 48 hours. For the positive naive controls, the scores were 0.0 for both 24 and 48 hours.

Severity Index—The severity indices are shown in Table 18. For the test group, the severity index scores were 0.1 and 0.0 at 24 and 48 hours, respectively. For the test naive control and positive naive control, the severity scores were 0.0 for both 24 and 48 hours. For the positive control group, the scores were 2.0 land 1.6 at 24 and 48 hours, respectively.

### Conclusions

The results of this test indicate that the test material does not have a potential to be a contact sensitizer in Hartley albino guinea pigs.

All eight positive control animals, dosed with a 0.025% solution of DNCB, exhibited response scores of 2 at the 24 hour observation and responses of 0.5 to 2 after the 48 hour observation. All eight of the positive naive controls had responses no greater than 0.5. These results indicate that a positive response can be elicited to a known sensitizer.

TABLE 13
Scoring Key

| Description | Score |
|---|---|
| No Reaction | 0 |
| Slight patchy erythema | 0.5 |
| Slight confluent or moderate patchy erythema | 1 |
| Moderate erythema | 2 |
| Erythema, edema, or cracking of the skin | 3 |

TABLE 14
Primary Irritancy Screen - Positive Control, 24 Hour Scores

Concentration (% wt in 9.5% aqueous ETOH)

| Animal | 0.1% | 0.05% | 0.025% | 0.01% |
|---|---|---|---|---|
| 47192 | 1 | 0.5 | 0 | 0 |
| 47525 | 0 | 0 | 0 | 0.5 |
| 47526 | 0 | 1 | 0.5 | 0 |
| 47737 | 0.5 | 0 | 0 | 0 |

TABLE 15
Induction Phase Scores

| | | | Third |
|---|---|---|---|
| Animal | First Exposure | Second | Exposure |
| Test Group | | | |
| 54127 | 0 | 0 | 0 |
| 54128 | 0 | 0 | 0 |
| 54129 | 0 | 0 | 0 |
| 54132 | 0 | 0 | 0.5 |
| 54213 | 0 | 0 | 0 |
| 54254 | 0 | 0 | 0 |
| 54278 | 0 | 0 | 0 |
| 54279 | 0 | 0 | 0 |
| 54324 | 0 | 0 | 0 |
| 54325 | 0 | 0 | 0 |
| 54332 | 0 | 0 | 0 |
| 54342 | 0 | 0 | 0 |
| 54344 | 0 | 0.5 | 0 |
| 52348 | 0 | 0 | 0 |
| 54349 | 0 | 0 | 0 |
| 54361 | 0 | 0.5 | 0 |
| 54365 | 0 | 0 | 0 |
| 54384 | 0 | 0 | 0 |
| 54339 | 0 | 0 | 0 |
| 54272 | 0 | 0 | 0 |
| Positive Control | | | |
| Group | | | |
| 47406 | 0 | 3 | 3 |
| 47408 | 0.5 | 2 | 2 |
| 47422 | 0 | 2 | 2 |
| 47457 | 0.5 | 2 | 2 |
| 47465 | 0 | 3 | 3 |
| 47467 | 0.5 | 2 | 3 |
| 47468 | 0 | 2 | 3 |
| 47490 | 0 | 3 | 3 |

TABLE 16
Primary Challenge Phase Scores

| | First | Second |
|---|---|---|
| | Observation | Observation |
| Animal Number | 24 Hour | 48 Hour |
| Positive Control Group | | |
| 47406 | 2 | 2 |
| 47408 | 2 | 0.5 |
| 47422 | 2 | 1 |
| 47457 | 2 | 2 |
| 47465 | 2 | 1 |
| 47467 | 2 | 2 |
| 47468 | 2 | 2 |
| 47490 | 2 | 2 |
| Positive Naive Control | | |
| 47409 | 0 | 0 |
| 47411 | 0.5 | 0 |
| 47414 | 0 | 0 |
| 47415 | 0 | 0 |
| 47420 | 0 | 0 |
| 47455 | 0 | 0 |
| 47488 | 0.5 | 0.5 |
| 47493 | 0 | 0 |
| Positive Control Group | | |
| 47406 | 2 | 2 |
| 47408 | 2 | 0.5 |
| 47422 | 2 | 1 |
| 47457 | 2 | 2 |
| 47465 | 2 | 1 |
| 47467 | 2 | 2 |
| 47468 | 2 | 2 |
| 47490 | 2 | 2 |
| Positive Naive Control | | |
| 47409 | 0 | 0 |
| 47411 | 0.5 | 0 |
| 47414 | 0 | 0 |
| 47415 | 0 | 0 |
| 47420 | 0 | 0 |
| 47455 | 0 | 0 |
| 47488 | 0.5 | 0.5 |
| 47493 | 0 | 0 |

TABLE 17
Incidence Score of Test Sites

| | | Test | | Positive |
|---|---|---|---|---|
| | Test | Naive | Positive | Naive |
| 24 Hours | Group | Control | Control | Control |
| 48 Hours | 0.0 | 0.0 | 1.0 | 0.0 |
| | 0.0 | 0.0 | 0.9 | 0.0 |

*Incidence Score: This is the number of animals in each group showing responses of 1 or greater at 24 or 48 hours, divided by the total number of animals in the group.

TABLE 18
Severity Index of Test Sites

| | | Test | | Positive |
|---|---|---|---|---|
| | Test | Naive | Positive | Naive |
| 24 Hours | Group | Control | Control | Control |
| 48 Hours | 0.1 | 0.0 | 2.0 | 0.1 |
| | 0.0 | 0.0 | 1.6 | 0.1 |

*Severity Index: This is the sum of the test scores divided by the total number of animals treated in a given group.

### EXAMPLE 11

### Acute Oral Toxicity

At an oral dose of 5,000 mglkg of body weight in 5 male and 5 female Sprague-Dawley rats, CIPP 225 produced no mortalities.

Sample preparation: Prior to administration, a 15 g portion of the test material was diluted to 30 ml with deionized water as a 50% solution (wt/vol).

Animal preparation: The animals were fasted 17 hours prior to dosing. Food was restored to the cages 3 hours after dosing.

Dosing procedure: The dose was administered 10 ml per kg body weight. The dose was administered with an oral gavage needle attached to a hypodermic syringe. Two control rats, one male and one female, animals.

Clinical observations: All of the animals were observed on the day of dosing and at least once each day for fourteen days. The animals were observed on the day of dosing and at least once each day for fourteen days. The animals were observed for clinical signs of toxicity wuch as unkempt appearance, altered feeding habits, weight loss, and other signs of distress or physical depression, and for any signs of recovery from these signs. These signs were recorded for each animal exhibiting them. Observations included onset, description, and duration.

Weights: All of the animals were weighed on day 0 (prior to test material administration), Day 7, and Day 14.

Necropsy: At the end of the test (Day 14), the animals were euthanized by intraperitoneal injection of sodium pentobarbital and gross necropsies were performed.

Results:

Clincal observations: No toxic signs in either the test group or vehicle control rats were observed during the 14 day observation period.

Weights: All of the animals gained weight and remained healthy during the test period.

Necropsy: Upon gross necropsy, no abnormalities were observed in the test or control animals.

### EXAMPLE 12

In this study the compositions of several preferred embodiments are compated to CIPP 225 for their available iodine content, color/clarity and pH. Table 1 9 shows the compositions of several examples of the preferred embodiment. Table 20 shows data comparing several properties of the preferred embodiments.

TABLE 19

| Ingredient | CIPP225 | CIPP2 | CIPP4 | CIPP5 |
|---|---|---|---|---|
| Sodium iodide | 0.25 | 0.25 | 0.25 | 0.25 |
| Citric acid | 1.6 | 1.6 | 1.6 | 1.6 |
| Sodium persulfate | 0.8 | — | — | — |
| Sodium percarbonate | 0.03 | 0.2 | 0.03 | 0.03 |
| Sodium perborate | — | — | 0.16 | — |
| Urea hydrogen peroxide | — | — | — | 0.07 |

TABLE 20

| | Available | | |
|---|---|---|---|
| Embodiment | iodine (ppm) | Color/Clarity | pH |
| CIPP225 | 180-184 | Medium gold/Clear | 2.5 |
| CIPP2 | 170-180 | Medium gold/Clear | 2.5 |
| CIPP4 | 175-184 | Medium gold/Clear | 2.5 |
| CIPP5 | 184-187 | Medium gold/Clear | 2.5 |

Conclusion: The embodiment of this application exhibit similar chemical properties.

### EXAMPLE 13

In this study, the effectiveness of several preferred embodiments, having the compositions shown in Table 19, are compared to embodiment CIPP225 against salmonella enteriditis. Table 21 shows the log reduction of S. enteriditis after 5 minutes exposure to the preferred embodiments at 25° C.

TABLE 21
Effectiveness of preferred embodiments against
S. enteriditis at 25° C.

| | Available iodine | |
|---|---|---|
| Embodiment | (ppm) | Log reduction (5 min) |
| CIPP225 | 171 | 7.03 |
| CIPP2 | 159 | 6.99 |
| CIPP4 | 168 | 6.89 |

Conclusions: The embodiments at 25° C. exhibit comparable effectiveness when tested against s. enteriditis with 5 minutes contact time.

All publications and patent documents cited in this application are incorporated by reference in their entirety for all purposes.

### EQUIVALENTS

It will be appreciated that the methods and compositions of the present invention are capable of being incorporated in the form of a variety of embodiments, only a few of which have been illustrated and described above. While specific examples have been provided, the above description is illustrative and not restrictive. The invention may be embodies in other specific forms without departing from its spirit or essential characteristics. The described embodiments are to be considered in all respects only as illustrative and not restrictive. The scope of the invention is, therefore, indicated by the appended claims rather than the foregoing description. All changes which come within the meaning and range of equivalency of the claims are to be embraced within the scope of the invention.

What is claimed is:

1. process for removing biofilm from a medical unit water line, the process comprising:
providing a medical unit water line, the water line being contaminated with a naturally acquired biofilm; and
filling the medical unit water line with an aqueous solution containing an iodide salt, an organic acid, and one or more oxidizing agents; and
allowing the solution to remain in the water line for a period sufficient to remove the biofilm; and
flushing the medical unit water line with water.

2. The process in claim 1 wherein the medical unit water line has been exposed to a backflow of human saliva.

3. The process of claim 1 wherein the medical unit water line has a maximum inner diameter of approximately 3.5 mm.

4. The process of claim 1 wherein the medical unit water line is a dental unit water line.

5. The process of claim 9 wherein the iodide salt is present as a sodium or potassium salt.

6. The process of claim 1 wherein the organic acid is citric acid.

7. The process of claim 1 wherein the oxidizing agents are chosen from the group consisting of sodium persulfate, sodium percarbonate, sodium perborate and urea hydrogen peroxide.

8. The process of claim 1 wherein the solution is not corrosive to plastic or metal parts of the water line.

9. The process of claim 1 wherein the water lines are free of residual biofilm removing solution after completion of the process.

10. The process of claim 1 wherein the solution is not toxic.

11. A Composition for removing biofilm from a medical unit water line, the composition consisting of an aqueous solution containing approximately 0.25% sodium iodide, 1.6% citric acid, 0.2% sodium percarbonate.

12. The composition of claim 11 wherein sodium percarbonate is present at approximately 0.09% to 0.2%

13. The composition of claim 11 wherein the oxidant component in the solution is a combination of approximately 0.8% sodium percarbon ate and 0.033% sodium percarbonate.

14. The composition of claim 11 wherein the oxidant component in the solution is a combination of approximately 0.033% sodium percarbonate and 0.08% to 0.16% sodium perborate.

15. The composition of claim 11 wherein the oxidant component in the solution is a combination of approximately 0.033% sodium percarbonate and 0.075% to 0.15% hydrogen peroxide.

16. A process for removing biofilm From a medical unit water line, the process comprising
providing a medical unit water line, the water line being contaminated with a naturally acquired biofilm,; and
filling the medical unit water line with a solution containing at least approximately 0.25 g sodium iodide, 1.6 g citric acid, 0.8 g sodium persulfate, and 0.03 g sodium percarbonate dissolved in 1 liter of water; and
allowing the solution to remain in the water line for a period sufficient to remove the biofilm; and
flushing the medical unit water line with water; and
wherein the solution contains no horse radish peroxidase.

17. The process of claim 16 wherein the medical unit water line has been exposed to la backflow of human saliva.

18. The process of claim 16 wherein the medical unit water line has a maximum inner diameter of approximately 3.5 mm.

19. The process of claim 16 wherein the medical unit water line is a dental unit water line.

20. The process of claim 16 wherein the solution is not biologically sensitizing.

21. The process of claim 16 wherein the solution is not corrosive to plastic or metal parts of the water line.

22. The process of claim 16 wherein the water lines are free of residual chemicals from the solution after completion of the process.

23. The process of claim 16 wherein the solution is not toxic.

24. A composition for removing biofilm from a medical unit water line, the composition consisting of
solution containing approximately 0.25 g sodium iodide, 1.6 g citric acid, 0.8 g sodium persulfate, and 0.03 g sodium percarbonate dissolved in 1 liter of water.
